(19) United States
(12) Patent Application Publication
(10) Pub. No.: US 2026/0148307 A1
(43) Pub. Date: May 28, 2026

(54) SYSTEM AND METHOD FOR PERFORMING ESTATE SETTLEMENTS

(71) Applicants: John M. Gomery, Carrollton, VA (US); Terry J. Johnson, State College, PA (US)

(72) Inventors: John M. Gomery, Carrollton, VA (US); Terry J. Johnson, State College, PA (US)

(21) Appl. No.: 19/453,675

(22) Filed: Jan. 20, 2026

Related U.S. Application Data
(60) Provisional application No. 63/756,360, filed on Feb. 10, 2025.

(51) Int. Cl. G06Q 40/06; G06Q 20/40; G06Q 50/18

(52) U.S. Cl. CPC G06Q 40/06; G06Q 20/40; G06Q 50/186

(57) ABSTRACT

A computer implemented method for performing estate settlements includes establishing secure communication between a platform provider system and a user interface device of an account owner. The method includes uploading asset information, financial obligations, a last will and testament, and the identity of the account owner. The method includes receiving a notification that the account owner has died, sending a request for confirmation to the account owner, and notifying the personal representative of the death of the account owner. The method also includes receiving a death certificate of the account owner, performing identity verification of the personal representative, and providing read-only access to the account owner information for use by the personal representative in performing an estate settlement of the deceased account owner.

### CROSS-REFERENCE TO RELATED APPLICATIONS

This application claims the benefit of U.S. Application Ser. No. 63/756,360 filed on Feb. 10, 2025, the contents of which are incorporated herein by reference.

### TECHNICAL FIELD

The present invention relates generally to the field of automation, and more particularly to a system and method for performing estate settlements.

### BACKGROUND

The statements in this section merely provide background information related to the present disclosure and may not constitute prior art.

It is an unfortunate fact of life that everyone will eventually die. When death occurs, it becomes necessary for the personal representative, executor, or trustee of the deceased to wrap up their financial and legal affairs in a process called estate settlement. The process typically begins by first determining if the deceased had a will. If so and depending on the assets belonging to the deceased at the time of death, it may be necessary for the executor to file a copy of the will with a probate court.

From there, the executor must go through the arduous task of attempting to determine what assets belonged to the deceased and their respective locations. This can be extremely difficult process because most people do not keep all their financial information in one place. As such, executors often spend weeks or even months searching through paperwork, digital accounts, old statements, and personal belongings to figure out what the person owned. Unfortunately, many of these documents such as online bank accounts, investment apps, digital wallets, or safe-deposit boxes are not readily obvious unless the deceased left clear instructions.

In addition to the above, other assets may be spread across multiple institutions and/or may involve property interests in multiple states. When these assets are identified, the executor must contact the respective banks, employers, and government agencies to attempt to gain access to the assets before being able to distribute them.

Accordingly, it would be beneficial to provide a system and method for performing estate settlements that can aid executors, trustees and other individuals in handling the estate settlement process of a person so as to overcome the drawbacks noted above which leads to lost assets.

### SUMMARY OF THE INVENTION

The present invention is directed to a computer implemented method for performing estate settlements. One embodiment of the present invention can include establishing communication between a platform provider system and a user interface device of an account owner. Once established, the account owner can upload asset information, financial obligations, their last will and testament, and the identity of their personal representative to the platform provider database.

In one embodiment, the platform provider system can receive a notification that the account owner has died. Upon receipt, the platform provider system can send a request for confirmation to the account owner, and unless contradicted, can notify the personal representative of the death of the account owner.

In one embodiment, the personal representative can provide a death certificate to the platform provider system and undergo an identity verification process. Upon successful verification, the platform provider system can provide the personal representative read-only access to the account owner information to be used in performing an estate settlement of the deceased account owner.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 shows an exemplary network environment according to some embodiments of the technology.

FIG. 2 shows an exemplary flow diagram illustrating a method for performing estate settlement, according to one embodiment.

FIG. 3 shows an exemplary user interface of the system of FIG. 1.

FIG. 4 shows another exemplary user interface of the system of FIG. 1.

FIG. 5 shows yet another exemplary user interface of the system of FIG. 1.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Any element in a claim that does not explicitly state “means” for performing a specified function or “step” for performing a specified function should not be interpreted as a “means” or “step” clause as specified in 35 U.S.C. 112.

### Definitions

As described throughout this document, the term “Account Owner” is used to describe any person utilizing the below described system and method to provide assets and other information to allow their designated Executor or Trustee to perform estate settlement using the system architecture.

The term “Personal Representative” is used to describe any person or entity designated by an Account Owner to selectively utilize the below described system and method to view and distribute the assets provided by the account owner. In this regard, the personal representative may also be a designated Executor and/or Trustee of the account owner.

The term “Platform Provider” describes the individual, group or legal entity that is overseeing the below described system in order to perform the methods described herein. In the preferred embodiment, the platform provider can operate utilizing one or more websites and can have access and permission to utilize Social Security's Death Index (SSDI).

In various embodiments, certain aspects of the method and system can be performed in any number of different manners, and can utilize any number of different websites, website URLs, and/or computer networks. Additionally, it is contemplated that some of the functionality described herein can also be performed simultaneously via different websites that are directed towards different uses and/or geographic locales. Such functionality can be performed under the direct supervision of the original platform provider, or via secondary site owners through a franchise, licensing, or other type of arrangement.

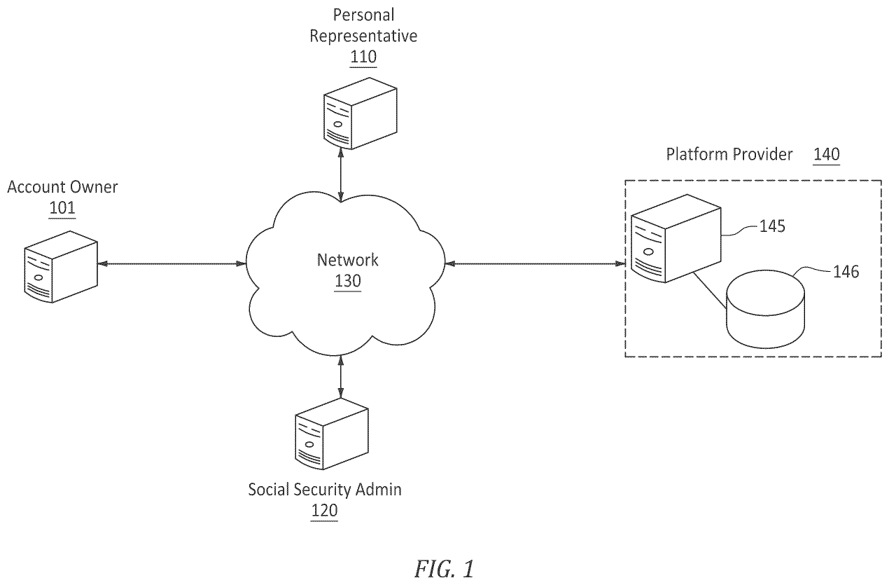

FIG. 1 is a block diagram of an example system operating environment for the automated estate settlement process on which the below described methodology may be implemented.

In one embodiment, the system 100 can include, for example, an Account Owner interface device 101 operated by an Account Owner, a Personal Representative interface device 110 that is operated by the Personal Representative of the Account Owner, and a Social Security Administration interface device 120 that is operated by the Social Security Administration of the United States, or other government agency. Each of the interface devices are connected over a network 130 to a Platform Provider Server 140 that is operated by the platform provider.

Each of the one or more interface devices 101, 110, and 120 can be any form of computing device that can be operated or controlled by a human user to perform the below described methodology. A computing device refers to any device with a processor and memory that can execute instructions and communicate with another device. Computing devices include, but are not limited to, personal computers, laptop computers, smartphones, tablet computers, and/or purpose-built machines that are pre-encoded with an application interface, so as to perform the functionality described.

In some embodiments the interface device, such as the account owner interface device 101 and/or the personal representative interface device 110 can comprise a smartphone device having a web browser and internet connectivity for communicating with the platform provider over the internet or via a mobile application (i.e., App) that can be downloaded and installed as an application for use on the smartphone or other such portable electronic device. Of course, the inventive concepts disclosed herein are not to be construed as limiting to a mobile application, as virtually any type of instruction sets, in any form of programming language that can be executed on any type of processor enabled device are also contemplated.

In either instance, each of the computing devices can include one or more client applications, such as a conventional web browser, and/or an application interface, for example, which can allow the device to communicate with other interface devices and/or the platform provider 140 over a network 130.

The Platform Provider server 140, according to one embodiment, can include one or more individual computing devices 145 that can be connected to one or more databases 146 on which various portions of the method can be performed. The server 140 can function to provide a central hub for controlling the communication between the interface devices through any number of different mediums such as the above noted website, for example. In this regard, one or more of the individual computing devices 145 can comprise a web server, an email server, an application database server and so forth, or the system can employ a single server device which functions to handle each of these processes.

In this regard, portions of the described methodology can be implemented as a computer program product, i.e., a computer program tangibly embodied in a non-transient machine-readable storage device, for execution by, or to control the operation of, a data processing apparatus. The computer program can be written in any form of computer or programming language, including source code, compiled code, interpreted code, scripting code (e.g., JavaScript) and/or machine code, and the computer program can be deployed in any form, including as a stand-alone program or as a subroutine, element, or other unit suitable for use in a computing environment.

The database 146 can function to receive and store information provided by the user interfaces for enabling the system to operate in the manner described below. As described herein, the database 146 can include any type of computer-readable storage mediums, including all forms of volatile and non-volatile memory such as, for example, semiconductor memory devices, e.g., DRAM, SRAM, EPROM, EEPROM, and flash memory devices; magnetic disks, e.g., internal hard disks or removable disks; magneto-optical disks; and optical disks, for example.

In addition, the devices can be operatively coupled to a communications network 130 to receive instructions and/or data from the network and/or to transfer instructions and/or data to the network. In one embodiment, the database or a portion thereof can include, comprise, or consist of blockchain technology for creating and storing information.

The network 130 can be any type of communication network that facilitates any form or medium or digital or analog communication. Several nonlimiting examples include the internet, a cellular network, a local area network (“LAN”), an intranet, a wide area network (“WAN”), and/or any other type of data transmission and reception medium.

Information transfer over the network 130 can be performed by a communication module based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), a Global System for Mobile Communications (GSM) protocol, a Push-to-Talk (PTT) protocol, a PTT over Cellular (POC) protocol, a Real-time Messaging protocol (RTMP), a Real-time Media Flow Protocol (RTMFP) and/or other communication protocols.

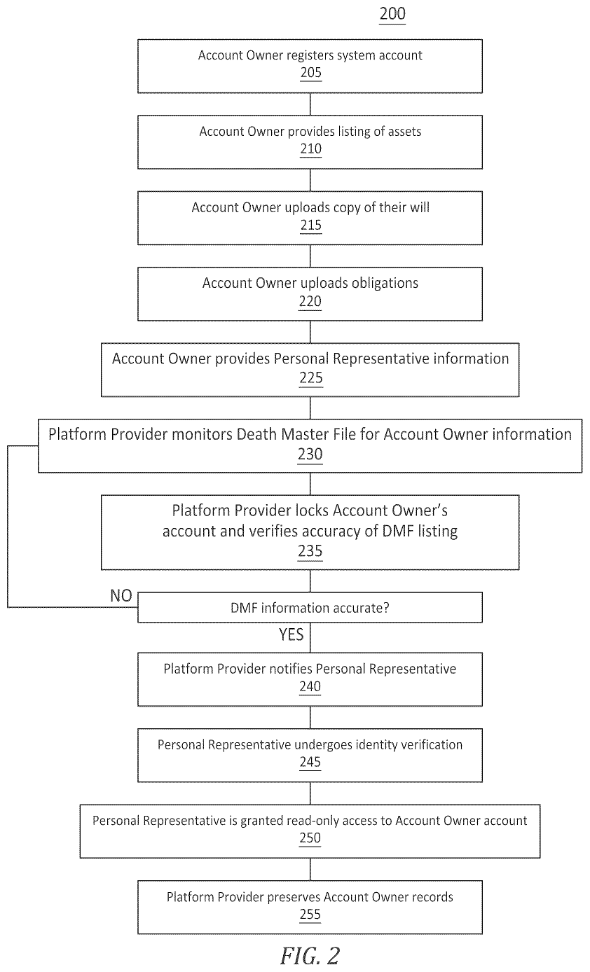

FIGS. 2-5 illustrate various methods and exemplary presentation screens for performing estate settlement procedures utilizing the system 100. Although described below with regard to particular method steps, this is for illustrative purposes only, as the steps can be performed in any order, and can also include any number of different steps, in order to achieve the inventive concepts disclosed herein. Moreover, while the methods illustrated below can be implemented by (and in some cases, are described with respect to) the system 100 of FIG. 1, (or components thereof), these methods and/or method steps may also be implemented utilizing other suitable hardware implementations.

In operation, the platform provider server can function to generate any number of presentation screens which can preferably be embodied in the form of a website and/or website pages that allow account holders and their personal representative to upload, read, copy, save and distribute information. To this end, the platform provider server can establish any number of presentation screens in the form of website pages, for example, such as an owner registration presentation screen, an owner asset listing presentation screen, a personal representative identity verification presentation screen, and others, for example.

FIG. 2 is a flow chart illustrating an exemplary method of performing estate settlement procedures utilizing the system 100 described above. The method 200 can begin at step 205 where a user establishes an account with the Platform Provider and undergoes a registration process to become a registered Account Holder. To this end, the registration process can include any number of different steps required by the platform provider for establishing the identity of the account holder. This process may include, for example, ID verification, biometric identification, and the establishment of a user password and payment responsibilities for the account, among others, for example.

Next, the method can proceed to step 210 where the Account Owner can provide a listing of their assets and submission of personal documents to be used in the estate settlement process. Several nonlimiting examples of personal documents used to identify assets can include, but are not limited to a comprehensive listing of all personal property, a comprehensive listing of all real property, and a comprehensive listing of all trusts and/or financial accounts with account numbers (e.g., checking accounts, savings accounts, investment accounts, retirement accounts, pensions, etc.), among others, for example.

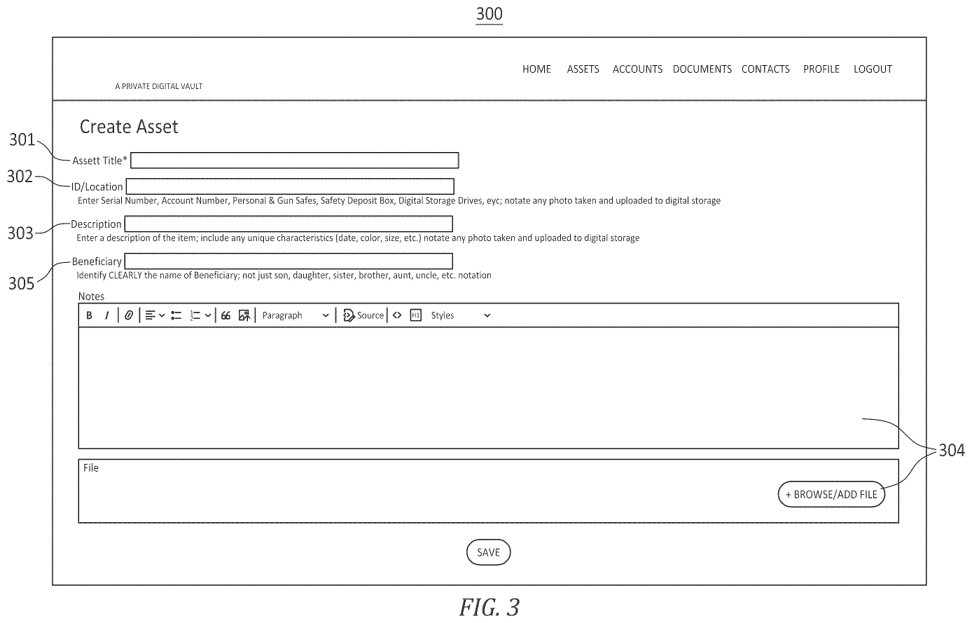

FIG. 3 illustrates an exemplary asset presentation screen which can be generated by the platform provider and displayed to the Account Owner at step 210. As shown, the exemplary presentation screen 300 can include options for allowing the account owner to provide the asset title 301, the location or account number 302, a description of the asset 303 including any photographs of notes 304, and the beneficiary 305 to whom the asset is to be conveyed upon the death of the account owner. Of course, the system can prompt the user for any other type of information pertaining to the assets.

Next, the method can proceed to step 215 where the Account holder can upload a copy of their last will and testament. At this time, the user can ensure that all assets identified at step 210 are accounted for in the will and that the beneficiary information is correct. In some instances, the platform provider can include functionality for utilizing artificial intelligence to compare the will with the assets and beneficiaries listed at step 210 to determine if any assets are missing from the will and/or if the beneficiary for one or more of the assets has changed. In such an instance, the platform provider can notify the account holder of the discrepancy and suggest the account holder visit an attorney to create a codicil to the will.

Next, the method can proceed to step 220, where the account holder can provide a listing of their financial obligations and submit any number of supporting documents to be used in the estate settlement process. Several nonlimiting examples of supporting documents used to identify obligations can include, but are not limited to bills such as commercial loans, mortgage information, property tax bills, child support bills, utility bills, and personal loans, for example.

Next, the method can proceed to step 225 where the account owner can identify their personal representative who will be responsible for wrapping up their financial and legal affairs through the estate settlement process. In this regard, the account owner can provide information about the personal representative, such as their full name, mailing address, email address, occupation, relationship to the account owner and the like. In some embodiments, the account owner can upload any supporting documents such as a power of attorney document, for example, to be used by the personal representative in performing their duties once the account owner has become deceased.

Next, the method can proceed to step 230, where the platform provider will monitor the Death Master File (DMF) that is posted each week by the United States Social Security Administration to determine if the Account Owner is listed as being deceased.

Upon determining the Account Owner is listed in the DMF, the Platform provider will immediately lock the account of the identified owner and will contact the Account Owner and their emergency contact seeking confirmation at step 235. To this end, the confirmation process can include any number of written, electronic (e.g., email, text), or verbal communications to the account owner.

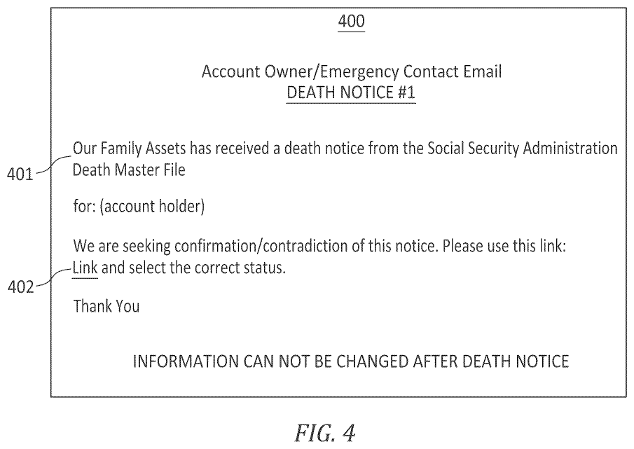

FIG. 4 illustrates an exemplary verification request document that can be created by the Platform Provider and sent to the Account Owner at step 235. As shown, the exemplary document 400 can include a notification 401 that the account owner is listed on the DMF. If the DMF erroneously lists the Account Owner, the system can provide a link 402 to which the Account Owner can respond to prove they are not deceased.

If the Account Owner clicks on the link 402, they will be prompted to verify their identity (e.g., biometric, live images, etc.) before the Platform provider will unlock the user account. In some instances, upon determining the Account Owner is erroneously listed on the DMF, the Platform Provider can provide guidance to the Account Owner in removing their name from the file. Upon verifying their information, the method returns to step 230.

If the Account Owner does not respond within a predetermined timeframe (e.g., 7 days), the method will proceed to step 240 where the Platform Provider will send a notification to the Personal Representative.

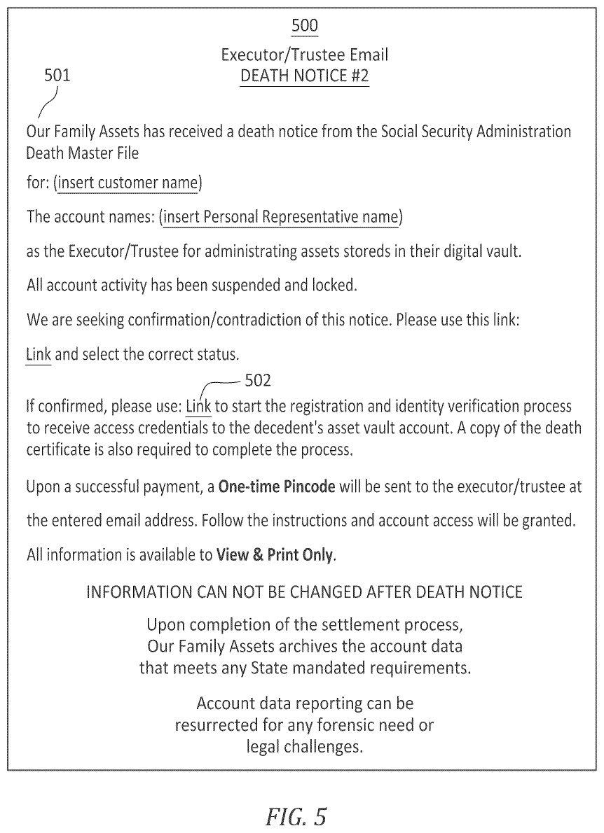

FIG. 5 illustrates an exemplary Death Notice document that can be created by the Platform Provider and sent to the Personal Representative of the Account Owner at step 240. As shown, the exemplary document 500 can include a notification 501 that the account owner is listed on the DMF, and instructions 502 for the Personal Representative to follow to gain access to the Account Owners account.

Next, the method will proceed to step 245, where the Personal Representative will be required to submit a copy of the Account Owner's death certificate before undergoing an identity verification and credentialing process where he or she will be required to provide supporting information (e.g., license, passport, official documents, biometrics, photographs, video, etc.) to confirm their identity.

Upon submission of the death certificate and completion of the identity verification process, the method will proceed to step 250 where the Personal Representative will be provided credentials for read-only access to the Account Owner's account. Importantly, the Personal Representative will be unable to make any changes to the account, especially in terms of asset listings and beneficiary designations. Upon settling the estate, the Platform Provider will maintain copies of the Account Owners files for a prescribed time, typically at least one year, as mandated by state or federal laws at step 255.

Accordingly, the above noted system greatly alleviates errors, and the extra time required by personal representatives in managing estate proceedings by ensuring they are provided the most up to date copy of a decedent's will, along with a full and complete listing of all assets, and financial obligations with supporting documentation. Moreover, by storing the information for legal or audit purposes, the system ensures no fraud occurs by the Personal Representative in the distribution of the assets of the deceased.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

Any element in a claim that does not explicitly state “means” for performing a specified function or “step” for performing a specified function should not be interpreted as a “means” or “step” clause as specified in 35 U.S.C. 112. The corresponding structures, materials, acts, and equivalents of all means or step plus function elements in the claims below are intended to include any structure, material, or act for performing the function in combination with other claimed elements as specifically claimed.

The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method for performing estate settlements, comprising:
providing a platform system having a database;
establishing communication between a user interface device of an account owner and the platform system over a network;
providing options for receiving asset information of the account owner from the user interface device to the platform system;
providing options for receiving a personal representative information of the account owner from the user interface device to the platform system;
storing the provided client asset information and personal representative information on the platform system database;
determining, via the platform provider, a death of the account owner; and
providing access to the client asset information to the personal representative.

2. The method of claim 1, wherein said establishing communication includes performing an identity verification of the account owner.

3. The method of claim 1, wherein said providing options for receiving asset information includes:
generating, via the platform provider, an asset presentation screen configured to receive information from the user interface device.

4. The method of claim 3, wherein the asset presentation screen includes at least one of an asset title input field, an asset location or account number field, an asset description field, and an asset beneficiary field.

5. The method of claim 1, further comprising:
providing options for receiving a last will and testament will of the account owner from the user interface device to the platform system.

6. The method of claim 1, further comprising:
providing options for receiving financial obligation information of the account owner from the user interface device to the platform system; and
storing the received financial obligation information within the database.

7. The method of claim 1, further comprising:
monitoring, via the platform system, government records containing names of recently deceased persons.

8. The method of claim 1, further comprising:
monitoring, via the platform system, a death master file published by the United States Social Security Office.

9. The method of claim 8, further comprising:
sending a death confirmation request to the user interface device.

10. The method of claim 1, wherein the client asset information is stored on the platform system database for at least one year after the death of the account owner.
